(19) United States
(12) Patent Application Publication
(10) Pub. No.: US 2006/0077280 A1
(43) Pub. Date: Apr. 13, 2006

(54) Focus detection method and focus detection apparatus

(75) Inventor: Naoto Nakahara, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/245,034

(22) Filed: Oct. 7, 2005

(30) Foreign Application Priority Data
Oct. 7, 2004 (JP) 2004-295044

(51) Int. Cl. H04N 5/232

(52) U.S. Cl. 348/353

(57) ABSTRACT

A focus detection method for detecting a focus state of an object image in accordance with contrast values of the object image at a plurality of focus detection areas, includes capturing object images while moving a focusing lens group of a photographing lens stepwise within a predetermined range of movement; determining a contrast value of each captured object image; detecting at least one peak contrast value, which satisfies a predetermined condition for reliability, from the determined contrast values, on each focus detection area, obtained during movement of the focusing lens group; and selecting a peak contrast value detected in each of a predetermined number of areas of the focus detection areas at a same position of the focusing lens group or in a predetermined positional range of the focusing lens group, if the peak contrast value which satisfies the predetermined condition for reliability is not detected.

### BACKGROUND OF THE INVENTION

1. Field of the Invention

The present invention relates to a focus detection method and a focus detection apparatus for detecting a focus in accordance with the contrast of image data on a captured image.

2. Description of the Prior Art

As a conventional focus detection method for compact AF digital cameras, a contrast detection method for detecting a focus in accordance with the contrast of data on a captured image is known in the art. Conventional focus detection apparatuses using the contrast detection method operate to determine the position of a focusing lens group in which contrast of an object image (image data) which is captured by an image pickup device by repeating an image capturing operation while moving the focusing lens group between an infinite focus position and a closest focus position becomes maximum. Therefore, in such conventional focus detection apparatuses, an image capturing operation is performed successively at different positions of the focusing lens group while the focusing lens group is driven stepwise from the infinite (longest) focus position (position for bringing an object at infinity into focus) to the closest (shortest) focus position to obtain a contrast from a captured image signal at each different position of the focusing lens group, and a maximum value (peak value) of contrast among the contrast values obtained at the aforementioned different positions of the focusing lens group is determined so that the focusing lens group is driven to a position thereof where the maximum contrast value is obtained to bring the object into focus. Such a focus detection apparatus is disclosed in, e.g., Japanese Unexamined Patent Publication No. 2001-249267.

However, according to such a conventional focus detection method, in the case where more than one peak contrast value is determined due to a low-contrast or dark object, or in the case where not even one peak value can be determined, a presumptive focus position is set in accordance with the ON/OFF state of an electronic flash, whether or not the object is under fluorescent lighting, and other parameters. Therefore, in the case of a low-contrast object at a short distance, the camera is focused on a point far away from the object. Moreover, in the case where the camera is provided thereon with an LCD panel for indicating captured object images, it is sometimes the case that a captured object image indicated on the LCD panel is a badly out-of-focus image.

### SUMMARY OF THE INVENTION

The present invention has been devised in view of the above described problems in the conventional contrast detection method, and provides an improved focus detection method which makes it possible to reduce the chance of defocusing occurring even in the case of a low-contrast object.

According to an aspect of the present invention, a focus detection method for detecting a focus state of an object image in accordance with contrast values of the object image at a plurality of focus detection areas, respectively, the focus detection method including capturing a plurality of the object images while moving a focusing lens group of a photographing lens stepwise within a predetermined range of movement of the focusing lens group; determining a contrast value of each the captured plurality of object images; detecting at least one peak contrast value, which satisfies a predetermined condition for reliability, from the determined contrast values, on each of the plurality of focus detection areas, obtained during movement of the focusing lens group; and selecting a peak contrast value detected in each of a predetermined number of areas of the plurality of focus detection areas one of at a same position of the focusing lens group and in a predetermined positional range of the focusing lens group, in the case the peak contrast value which satisfies the predetermined condition for reliability is not detected.

It is desirable for the predetermined condition to include a first condition wherein a difference between the detected peak contrast value and a comparative peak contrast value is one of equal to and greater than a predetermined value.

It is desirable for the predetermined condition to include a second condition wherein a difference between the detected peak contrast value and a minimum contrast value among all contrast values obtained in one of the plurality of focus detection areas, in which the detected peak contrast value is detected, is one of equal to and greater than a predetermined value.

It is desirable for the predetermined condition to include a third condition wherein the detected peak contrast value is the greatest among all contrast values obtained in one of the plurality of focus detection areas in which the detected peak contrast value is detected.

The detected peak contrast value can be designated as a peak contrast value which increases a plurality of times consecutively and subsequently decreases a plurality of times consecutively along the direction of movement of the focusing lens group.

If the peak contrast value which satisfies the predetermined condition for reliability is not detected and if at least a predetermined number of peak contrast values one of at the same position of the focusing lens group and in the predetermined positional range of the focusing lens group are detected, it is desirable for a peak contrast value one of at a lens position of the focusing lens group which corresponds to a closest distance and in a predetermined positional range of the focusing lens group which corresponds to a closest distance to be selected in the selecting step.

If the peak contrast value which satisfies the predetermined condition for reliability is not detected and if at least a predetermined number of peak contrast values one of at the same position of the focusing lens group and in the predetermined positional range of the focusing lens group are selected in the selecting step, it is desirable for an average position of a plurality of lens positions of the focusing lens group which are obtained from the selected predetermined number of peak contrast values to be designated as an in-focus position of the focusing lens group.

It is desirable for the focusing detection method to further include moving the focusing lens group stepwise when the focus state of the object image is detected.

It is desirable for the contrast values of the object image to be measured via an image pickup device.

In an embodiment, a focus detection apparatus is provided, for detecting a focus state of an object image in accordance with contrast values of the object image at a plurality of focus detection areas, respectively, the focus detection apparatus including a lens drive mechanism for moving a focusing lens group of a photographing lens system within a predetermined range of movement; an image-capturing device for capturing a plurality of the object images while moving the focusing lens group stepwise within the predetermined range of movement of the focusing lens group; a contrast value determining device for determining a contrast value of each the captured plurality of object images; and a controller for detecting at least one peak contrast value, which satisfies a predetermined condition for reliability, from the determined contrast values, on each of the plurality of focus detection areas, obtained during movement of the focusing lens group. The controller selects a peak contrast value detected in each of a predetermined number of areas of the plurality of focus detection areas one of at a same position of the focusing lens group and in a predetermined positional range of the focusing lens group, in the case where the peak contrast value which satisfies the predetermined condition for reliability is not detected.

It is desirable for the controller to select a peak contrast value at a lens position of the focusing lens group which corresponds to a closest distance or in a predetermined positional range of the focusing lens group which corresponds to a closest distance, if the peak contrast value which satisfies the predetermined condition for reliability is not detected and if at least a predetermined number of peak contrast values one of at the same position of the focusing lens group and in the predetermined positional range of the focusing lens group are detected.

It is desirable for the controller to calculate an average position of a plurality of lens positions of the focusing lens group which are obtained from the selected predetermined number of peak contrast values and designates the average position as an in-focus position of the focusing lens group, if the peak contrast value which satisfies the predetermined condition for reliability is not detected and if at least a predetermined number of peak contrast values one of at the same position of the focusing lens group and in the predetermined positional range of the focusing lens group are selected.

It is desirable for the controller to move the focusing lens group stepwise when the focus state of the object image is detected.

It is desirable for the contrast values of the object image to be measured via the image-capturing device.

According to the present invention, excessive defocusing does not occur even if a correct focused state cannot be achieved because a peak contrast value which is detected in a predetermined number of areas of the plurality of focus detections areas, either at the same position of the focusing lens group or in a predetermined positional range of the focusing lens group, is selected if the peak contrast value which satisfies the predetermined condition for reliability is not detected.

Moreover, the time necessary for achieving a focused state from the commencement of the focus detecting operation can be reduced because a peak contrast value can be detected without the need for moving the focusing lens group over the full range of movement thereof.

The present disclosure relates to subject matter contained in Japanese Patent Application No. 2004-295044 (filed on Oct. 7, 2004) which is expressly incorporated herein in its entirety.

### BRIEF DESCRIPTION OF THE DRAWINGS

The present invention will be discussed below in detail with reference to the accompanying drawings, in which:

FIG. 1 is a block diagram of an embodiment of a digital camera to which the present invention is applied, showing a basic configuration of the digital camera;

FIG. 2 is a diagrammatic illustration showing the relative position between a light receiving surface of an image pickup device and five focus detection areas on the light receiving surface in the digital camera shown in FIG. 1;

FIG. 3 is a diagrammatic illustration showing the arrangement of primary-color filters of the image pickup device;

FIG. 4 is a flow chart showing a contrast AF process performed in the digital camera shown in FIG. 1;

FIG. 5 is a flow chart showing a sub-routine “Contrast Value Calculating Process” performed in the contrast AF process shown in FIG. 4;

FIG. 6 is a flow chart showing a sub-routine “Peak Check Process” performed in the contrast AF process shown in FIG. 4;

FIG. 7 is a flow chart showing a sub-routine “Peak Calculation Process” performed in the contrast AF process shown in FIG. 4;

FIG. 8 is a flow chart showing a sub-routine “Area Selection Process” performed in the contrast AF process shown in FIG. 4;

FIG. 9 is a flow chart showing a sub-routine “2UP-and-2Down Sampling Process” performed in the Area Selection Process shown in FIG. 8;

FIG. 10 is a flow chart showing a sub-routine “2Up-and-2Down Selection Process” performed in the Area Selection Process shown in FIG. 8;

FIG. 11 shows graphs indicating a relationship between contrast data obtained by the contrast AF process shown in FIG. 4 and the position of the focusing lens group L1 by way of example;

FIG. 12A is a table showing a relationship between the lens position (pulse number) and the number of peak contrast values which are obtained by the contrast AF process shown in FIG. 4;

FIG. 12B is a table showing a relationship between the focus detection area and the lens position in which the finally-selected peak contrast value exists; and

FIGS. 13A through 13D are graphs each illustrating the linear approximation of a peak contrast value in the contrast AF process shown in FIG. 4.

### DESCRIPTION OF THE PREFERRED EMBODIMENT

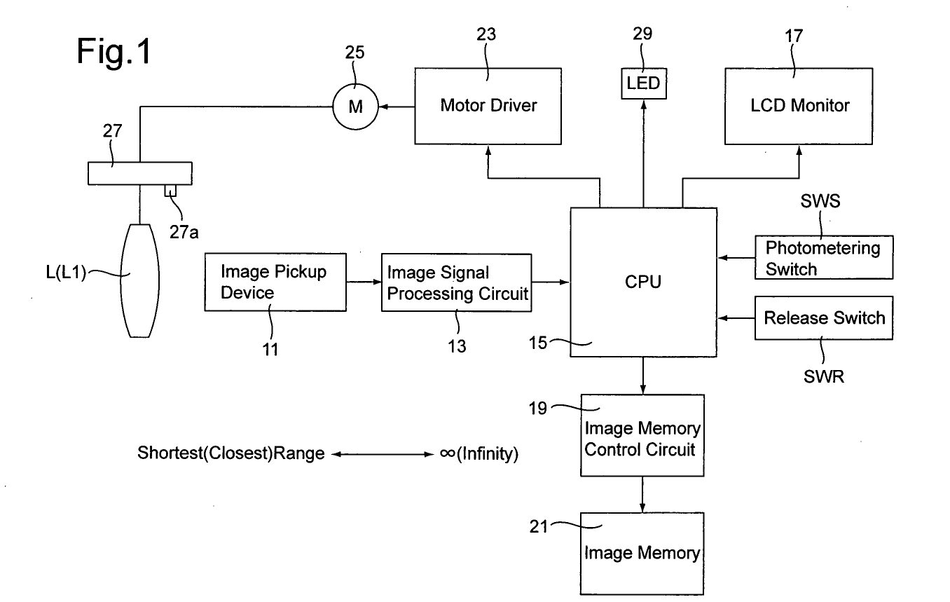

FIG. 1 is a block diagram of an embodiment of a digital camera to which the present invention is applied.

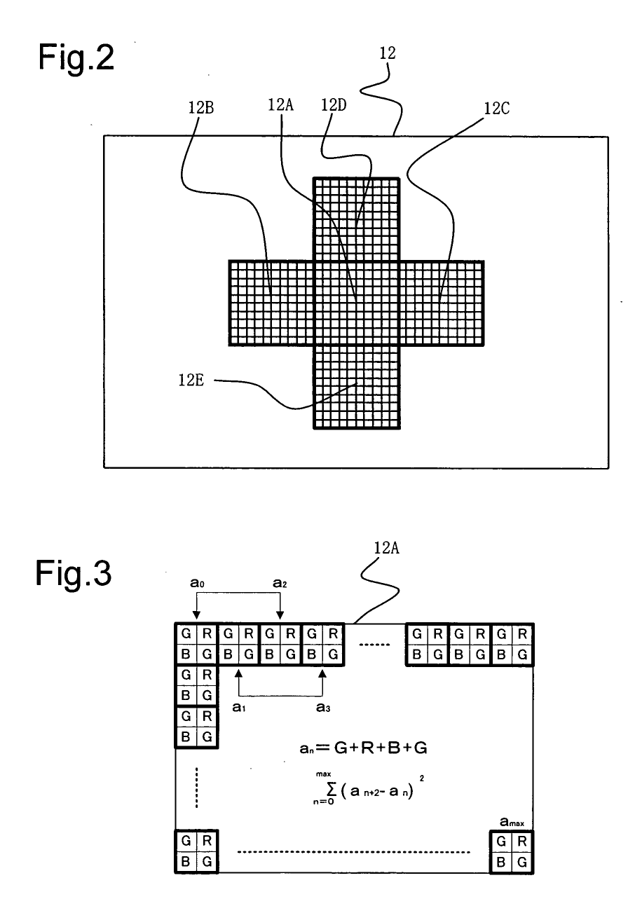

The digital camera is provided with a photographing lens L including a focusing lens group L1, and an image pickup device (CCD image sensor) 11 serving as a imaging-capturing device. An object image is formed on a light receiving surface 12 (see FIG. 2) of the image pickup device 11 via the photographing lens L. The image pickup device 11 includes a large number of pixels (photoelectric transducing elements/photo diodes) arranged in a two-dimensional matrix at predetermined intervals. The digital camera is further provided with an image signal processing circuit 13, a CPU (controller/contrast value determining device) 15, an LCD monitor 17, an image memory control circuit 19, an image memory 21, a motor driver 23, an AF motor 25 and a lens drive mechanism 27. Each pixel of the image pickup device 11 converts the incident light of an object image thereon into an electrical charge, and the electrical charges is accumulated (integrated). Upon completion of an exposure, the accumulated charges are output, pixel by pixel, as an image signal to the image signal processing circuit 13. The image signal processing circuit 13 performs predetermined adjusting processes such as a white-balance adjusting process and an A/D converting process on the input image signal to output digital image data to the CPU 15. Namely, predetermined processes are performed on the input image signal in the image signal processing circuit 13, and the image data which is digitized into pixel data is output to the CPU 15. The CPU 15 converts the input image data into an image signal capable of being indicated on the LCD monitor 17 to visually indicate the image data on the LCD monitor 17 in a through mode (monitoring mode), and converts the input image data into image data having a predetermined format to write this image data into the image memory 21 via the image memory control circuit 19. The digital camera is provided with an LED 29 (see FIG. 1) serving as a focus state indicator for indicating whether or not an in-focus state is achieved. For instance, the LED 29 illuminates green (or blue) when focus is achieved, and illuminates red (or blinks green (or blue)) when focus is not achieved.

FIG. 2 shows the relative position between the light receiving surface 12 of the image pickup device 11 and five focus detection areas: first through fifth focus detection areas 12A, 12B, 12C, 12D and 12E, arranged on the light receiving surface 12 in the shape of a cross, by way of example. FIG. 3 is an enlarged view of the first (central) focus detection area 12A. Each of the remaining four focus detection areas 12B through 12E has the same structure as the first focus detection area 12A, and accordingly, only the first focus detection area 12A is shown in FIG. 3. The first focus detection area 12A is positioned at substantially the center of the light receiving surface 12, the second and third focus detection areas 12B and 12C are positioned on laterally opposite sides of the first focus detection area 12A, and the fourth and fifth focus detection areas 12D and 12E are positioned on vertically opposite sides of the first focus detection area 12A. Primary-color filters (red (R), green (G) and blue (B) filters) are disposed in front of each pixel (photoelectric transducing element) on the object side thereof, and each pixel on the light receiving surface 12 transduces the red, green and blue components of the incident rays of object light that are passed through the primary-color filters into electrical charges, and these electrical charges are accumulated. The electrical charges thus accumulated for a predetermined period of time are read out of the image pickup device 11 pixel by pixel to be output as an image signal.

FIG. 3 shows a typical arrangement of primary-color filters. The primary-color filters include horizontal GR lines, each of which green filters and red filters are horizontally arranged in alternative order, and horizontal BG lines, each of which blue filters and green filters are horizontally arranged in alternative order, so that the GR lines and the BG lines are vertically arranged in alternative order. In the illustrated embodiment of the digital camera, four pixels (a 2 by 2 matrix of pixels) in each square, namely, a combination of two green filters, a red filter and a blue filter, is treated as one pixel block, and the sum of the magnitudes of image signals integrated by the four pixels in each pixel block is regarded as intensity aₙ (aₙ=G+R+B+G).

Accordingly, an operation for determining the difference between the intensity aₙ of a pixel block and the intensity aₙ of another pixel block positioned one pixel-block away from the previous pixel block in the horizontal direction is repeated successively in the horizontally rightward direction within the first focus detection area 12A while the differences thus determined (aₙ₊₂−aₙ) are added up. Upon completion of this difference determining and adding operations on the pixel block at the right end of the first focus detection area 12A in the horizontal direction, the difference determining and adding operations are repeated on a subsequent row of pixel blocks one pixel block below the previous row of pixel blocks in the vertical direction until completion of the determining operation on the pixel block at the right end of the first focus detection area 12A in the horizontal direction and completion of the adding operation thereof. Such difference determining and adding operations are repeated on all the pixel blocks in the first focus detection area 12A. Subsequently, the same operations are performed on each of the remaining four focus detection areas 12B through 12E.

The sum of the differences (aₙ₊₂−aₙ) on each of the first through fifth focus detection areas 12A through 12E corresponds to the contrast value on the focus detection area at the current position of the focusing lens group L1. The contrast value can be represented by the following expression 1:

$${\sum }_{n = 0}^{max} {( {a}_{n + 2} - {a}_{n} )}^{2} \qquad [ Expression 1 ]$$

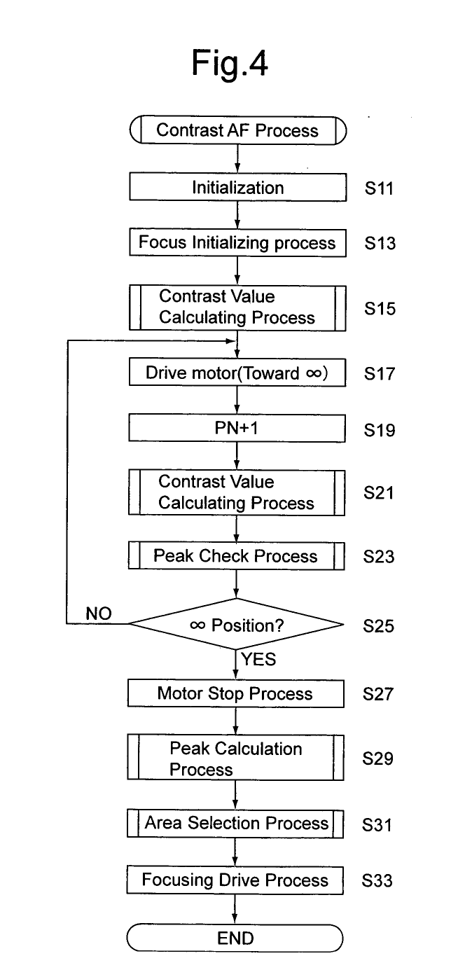

In a contrast AF process (see FIG. 4) performed by the CPU 15, the CPU 15 performs an image capturing operation on the image pickup device 11 while moving the focusing lens group L1 stepwise via the motor driver 23, the AF motor 25 and the lens drive mechanism 27; inputs the image signals from the first through fifth focus detection areas 12A through 12E to determine the contrast values on the first through fifth focus detection areas 12A through 12E, respectively; and stores the determined contrast values in an internal RAM of the CPU 15 as contrast data. The CPU 15 repeats the contrast AF process while moving the focusing lens group L1 stepwise in the direction from one end to the other end within the range of movement of the focusing lens group L1, i.e., from the closest (shortest) focus position (minimum focusing range position) to the infinite focus position (position for bringing an object at infinity into focus).

In the present embodiment of the digital camera, the position of the focusing lens group L1 is detected by an origin sensor 27a with the closest (shortest) focus position of the focusing lens group L1 being regarded as a point of origin, and is counted as the number of driving pulses from the point of origin. The driving pulses are defined as, e.g., pulses output from an encoder such as a photo-interrupter installed on the output shaft of the AF motor 25. Although several hundreds of pulses or more are usually necessary for driving the focusing lens group L1 from the closest (shortest) focus position to the infinite focus position, it is assumed that several pulses or several dozen pulses are only necessary for driving the focusing lens group L1 in a stepwise manner from the closest (shortest) focus position to the infinite focus position in the contrast AF process in the present embodiment of the digital camera. In addition, in the driving pulses used in the contrast AF process in the present embodiment of the digital camera, it is assumed that one driving pulse constitutes more than one pulse output from the aforementioned photo-interrupter.

Immediately after contrast data at each of the plurality of lens positions from the closest (shortest) focus position to the infinite focus position is obtained, contrast data at two adjacent lens positions of the focusing lens group L1 are compared with each other successively at consecutive lens positions in a direction of movement of the focusing lens group L1, e.g., in a direction from a position of the focusing lens group L1 on the close-distance range side to a position of the focusing lens group L1 on the long-distance side, to determine whether the contrast value increases successively a predetermined number of times and subsequently decreases successively a predetermined number of times. More specifically, in the present embodiment of the digital camera, it is determined whether the contrast value increases two times consecutively, and subsequently decreases two times consecutively in a group of contrast data (obtained contrast values) at consecutive five lens positions from the close-distance side or the long-distance side so as to determine a peak contrast value. In other words, it is determined whether the contrast data of the third (middle) lens position of the five lens positions is a peak contrast value or not. The same determining operation is performed successively on another group of contrast data at consecutive five lens positions which are shifted one by one toward either the long-distance side or the close-distance side with respect to the previous five lens positions. If it is determined that the contrast value increases two times consecutively and subsequently decreases two times consecutively, it is determined whether the reliability of a peak contrast value thereof is high (i.e., whether this peak contrast value is higher than the peak contrast value of the previous five lens positions). It is determined that a precise peak contrast value exists only when the reliability thereof is high.

Additionally, in the present embodiment of the digital camera, if it is determined that there is no peak contrast value having high reliability, it is determined whether the contrast value increases two times consecutively and subsequently decreases two times consecutively on a group of contrast data (obtained contrast values) at consecutive five lens positions from either the close-distance side or the long-distance side to detect a precise peak contrast value, similar to the above described manner. In this manner, a lens position of the focusing lens group L1 in which at least a predetermined number of peak values exists at the same position of the focusing lens group L1 is detected out of the peak contrast values determined on all the five focus detection areas. Thereafter, a more precise position of the focusing lens group L1 is determined from two contrast data positioned on the opposite sides of each peak contrast value by an approximate (interpolation) calculation, and the focusing lens group L1 is moved to a lens position thereof corresponding to an average of the determined precise positions of the focusing lens group L1. Thereupon, the LED 29 is activated to illuminate (or blink) in a manner such as described above to visually indicate that an in-focus state is not achieved.

Accordingly, according to the present embodiment of the focus detection method, peak contrast values are determined regardless of the reliability thereof when no precise peak contrast value having high reliability can be determined. Subsequently, if at least a predetermined number of peak contrast values exists at the same position of the focusing lens group L1, it is assumed that an in-focus point exists at or in the vicinity of this position of the focusing lens group L1, this process being a feature of the present invention.

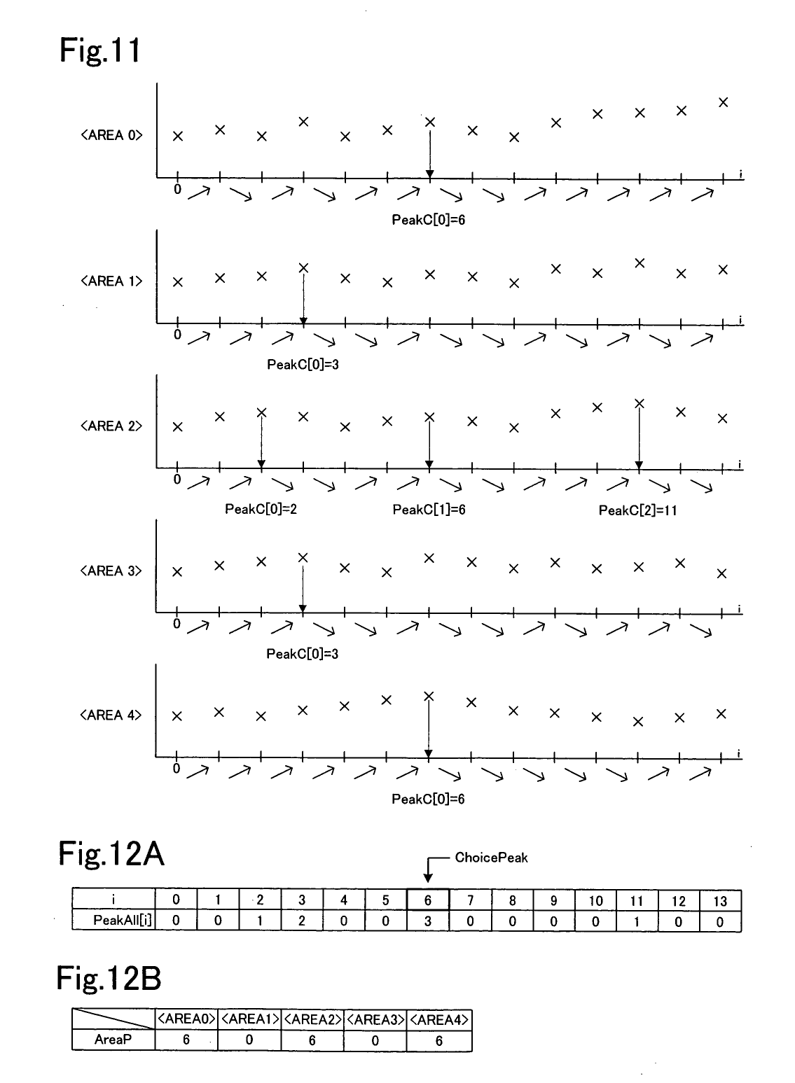

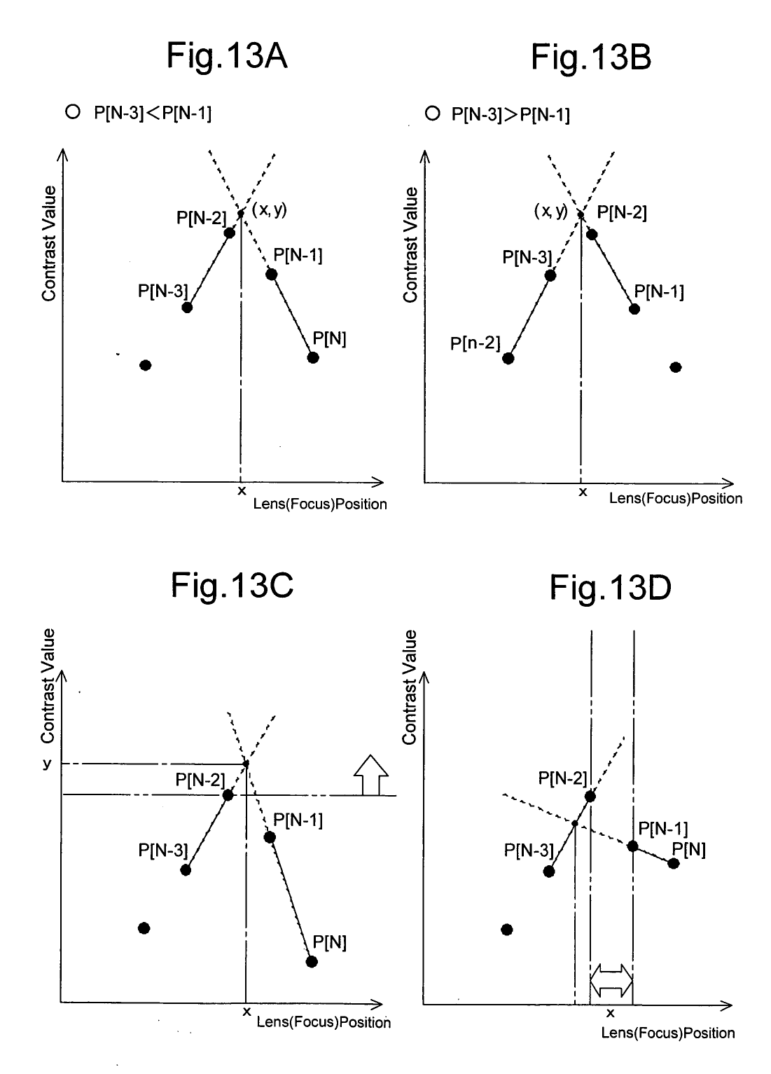

The contrast AF process that is performed in the present embodiment of the digital camera will be discussed in detail with reference to flow charts shown in FIGS. 4 through 10, graphs shown in FIG. 11 which show a relationship between contrast data obtained by the contrast AF process shown in FIG. 4 and the position of the focusing lens group L1 by way of example, a table shown in FIG. 12A which shows a relationship between the lens position (pulse number) and the number of peak contrast values which are obtained by the contrast AF process shown in FIG. 4, a table shown in FIG. 12B which shows a relationship between the focus detection area and the lens position in which the finally-selected peak contrast value exists, and graphs shown in FIGS. 13A through 13D, each of which illustrates the linear approximation of a peak contrast value in the contrast AF process shown in FIG. 4. In this particular embodiment, immediately after the photometering switch SWS is turned ON, control enters the contrast AF process shown in FIG. 4 to carry out this process only once. Namely, the contrast AF process shown in FIG. 4 is a one-shot AF process.

In the contrast AF process, firstly various variables and the like are initialized (step S11). For instance, each flag is cleared, contrast values are cleared, a lens position (pulse number) PN is initialized (PN=0), the maximum contrast value is set to zero, the minimum contrast value is set to FFFFFFFF, and the number of focus detection areas to be used is selected according to the focal length of the photographing lens L in the present embodiment of the digital camera. The lens position PN is a variable which is increased by one every time the focusing lens group L1 moves toward the infinite focus position by one pulse, wherein the lens position PN is zero when the focusing lens group L1 is in the closest (shortest) focus position. Note that the aforementioned number of focus detection areas to be used is selected from among predetermined different numbers according to the focal length of the photographing lens L to calculate the contrast value.

Upon completion of the initializing process at step S11, a focus initializing process is performed (step S13). In the focus initializing process, the focusing lens group L1 is moved to one of the opposite ends of the moving range of the focusing lens group L1, specifically to the closest (shortest) focus position in this particular embodiment. The origin sensor 27a detects whether or not the focusing lens group L1 reaches the closest (shortest) focus position.

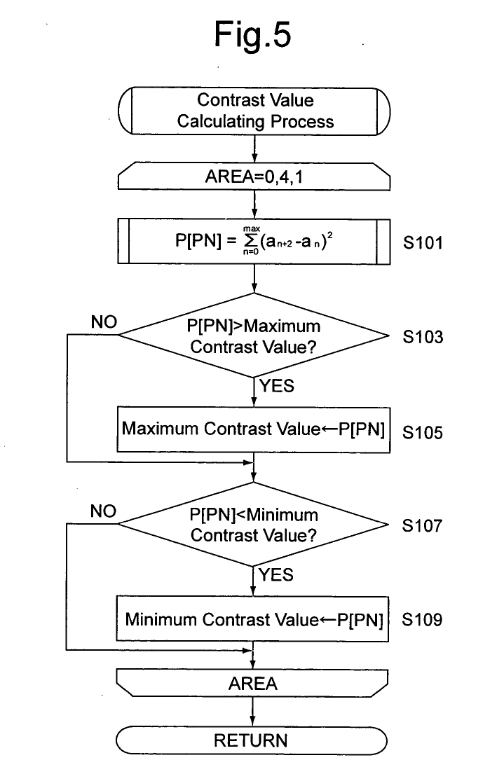

Thereafter, a contrast value calculating process (see FIG. 5) is performed to calculate a contrast value P[PN] at the current position of the focusing lens group L1, i.e., the closest (shortest) focus position thereof (step S15). Namely, a contrast value P[0] when the focusing lens group L1 is positioned at the closest (shortest) focus position is calculated in accordance with the image data input from the image pickup device 11, and each of the peak contrast value and the minimum contrast value is updated.

A motor driving process in which the AF motor 25 is driven stepwise in a direction to move the focusing lens group L1 toward the infinite focus position is started (step S17). Namely, the focusing lens group L1 is made to start moving stepwise, in increments of one lens position PN, in a direction from the closest (shortest) focus position to the infinite focus position. Subsequently, the lens position PN is increased by one (step S19).

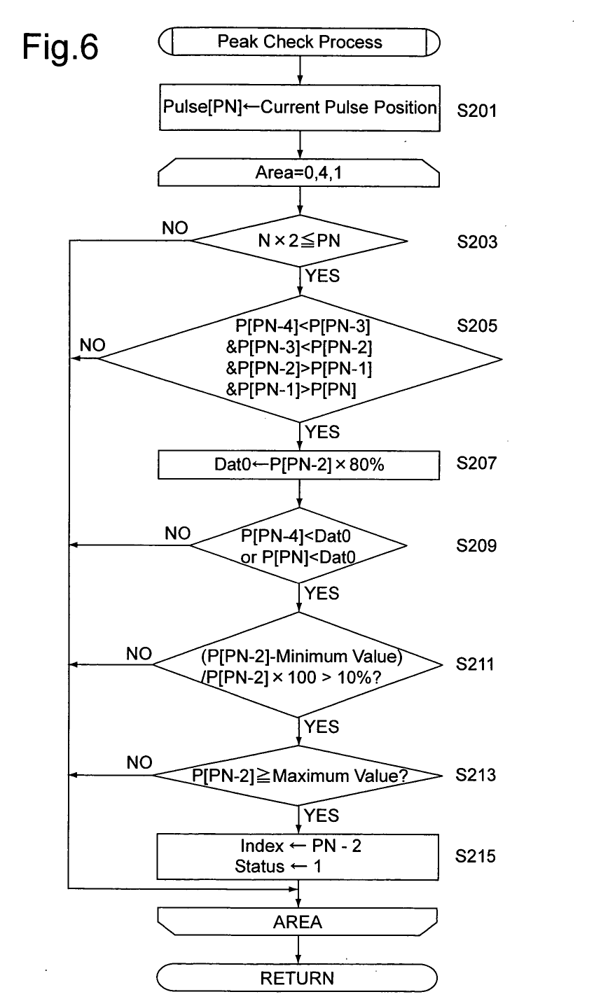

Subsequently, a contrast value calculating process is performed wherein the contrast value P[PN] is calculated in accordance with the image data input from the image pickup device 11, and each of the peak contrast value and the minimum contrast value is updated (step S21). Subsequently, a peak check process (see FIG. 6) which determines whether the contrast value P[PN] calculated at step S21 is a peak contrast value which satisfies predetermined conditions (step S23). The contrast value calculating process at step S21 and the peak check process at step S23 are performed on all the five focus detection areas 12A through 12E. Note that an area 0, an area 1, an area 2, an area 3 and an area 4 represent the focus detection areas 12A through 12E, respectively, in the following description.

Upon completion of the operation at step S23, it is determined whether the focusing lens group L1 has reached the infinite focus position (step S25). If it determined that the focusing lens group L1 has not yet reached the infinite focus position (if NO at step S25), control returns to step S17 so that the operations at steps S17 through S23 are repeated while the focusing lens group L1 is driven stepwise, in increments of one pulse, toward the infinite focus position. This process in which the peak check process is performed each time the focusing lens group L1 is driven stepwise in increments of one lens position PN makes it possible to reduce the processing time by a greater degree than the case where the peak check process is performed once, after the contrast values are obtained over the full range of movement of the focusing lens group L1 by driving the focusing lens group L1 from the closest focus position to the infinite focus position.

If the stepwise driving of the focusing lens group L1 is performed immediately after the readout of the image data from the image pickup device 11, and if the contrast value calculating process S21 and the peak check process S23 are performed during the stepwise driving of the focusing lens group L1, the processing time can be reduced, or the effective integral action time can be extended in a state where the focusing lens group L1 is at rest.

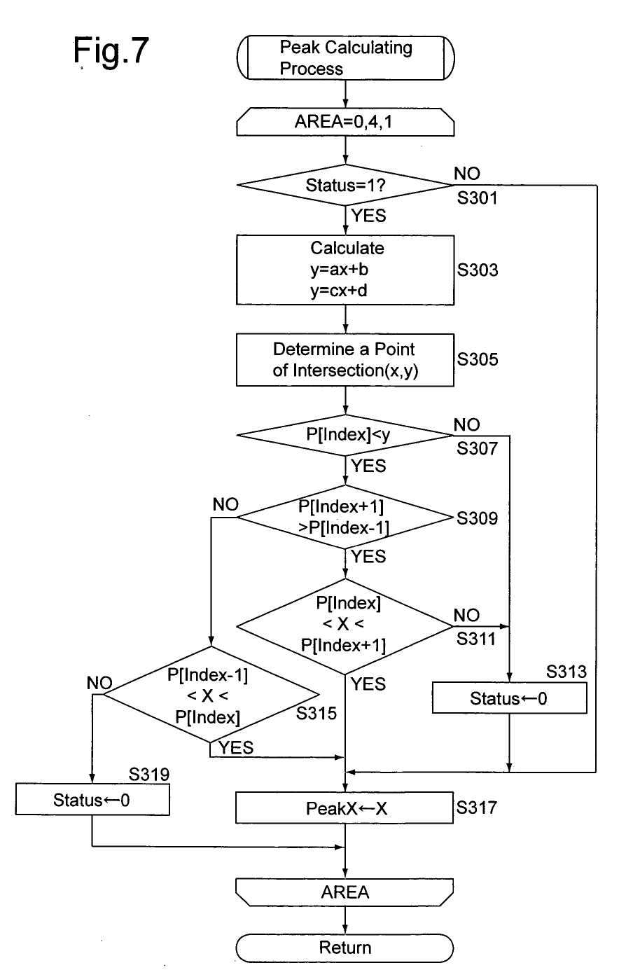

Immediately after the focusing lens group L1 reaches the infinite focus position after the completion of the contrast value calculating process at step S21 and the peak check process at step S23 (if YES at step S25), the AF motor 25 is stopped (step S27). Subsequently, a peak check process (see FIG. 7) for calculating a peak contrast value (by linear approximation) on each focus detection area is performed in accordance with the contrast values (a group of contrast data (five including peak contrast values) at consecutive five lens positions which are obtained in the loop process at steps S17 through S25 (step S29). Namely, a peak contrast value which is presumed to be a precise peak contrast value is determined by an interpolation calculation since there is a possibility of a real peak contrast value existing in the vicinity of a peak contrast value among the contrast values which are respectively determined at stepwise positions. In the present embodiment of the focus detection method, a point of intersection is determined between two straight lines (two linear approximation expressions): a straight line which passes through the points of two contrast values among the detected contrast values which are obtained on one of the opposite sides (e.g., the close-distance side) of a peak contrast value and another straight line which passes through the points of another two contrast values among the detected contrast values which are obtained on the other side (e.g., the infinite range side) of the peak contrast value. This point of intersection is assumed to correspond to a more precise peak contrast value.

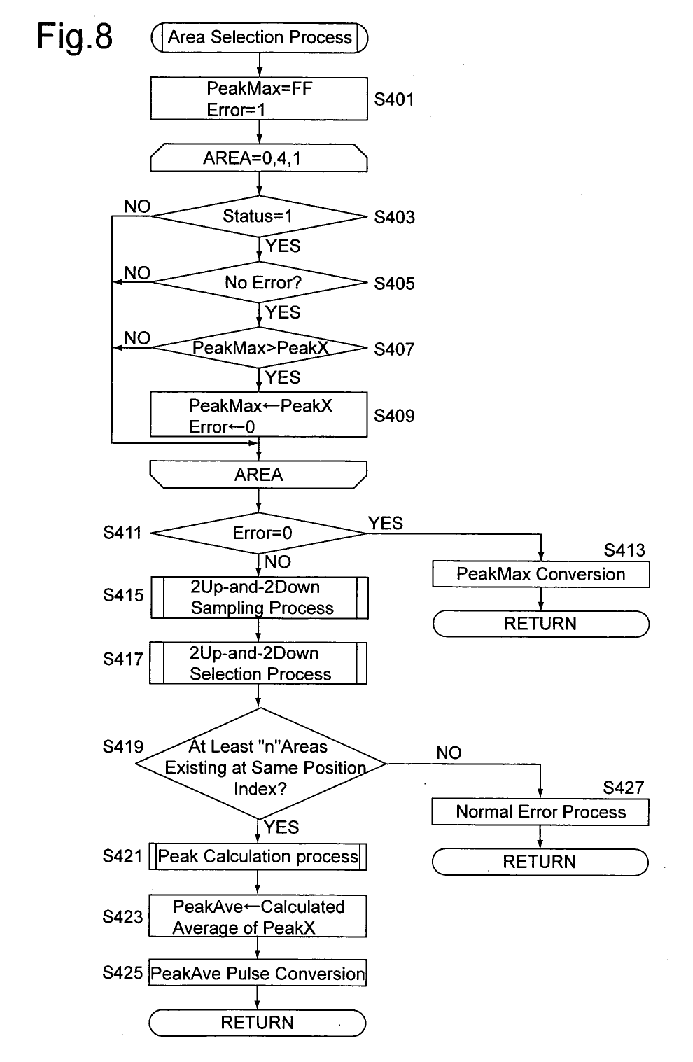

Subsequently, an area selection process (see FIG. 8) is performed (step S31). In the area selection process, one of the five focus detection areas 12A through 12E in which a peak contrast value at the closest distance is obtained is selected as an in-focus area in accordance with the peak contrast values obtained at each focus detection area (step S31). Thereupon, the focusing lens group L1 is moved to the focus position of the selected focus detection area 12A, 12B, 12C, 12D or 12D to bring an object into focus (step S33), which ends the contrast AF process.

[Contrast Value Calculating Process]

The contrast value calculating process that is performed at each step S15 and S21 will be hereinafter discussed with reference to the flow chart shown in FIG. 5. The contrast value calculating process is performed on each of the five focus detection areas 12A through 12E (the five areas 0 through 4).

In the contrast value calculating process, firstly the contrast value P[PN] is determined by the following expression 2 from the contrast data obtained at each lens position of the focusing lens group L1 (lens position (pulse number) PN) by moving the focusing lens group L1 stepwise (step S101):

$$P [ PN ] = {\sum }_{n = 0}^{max} {( {a}_{n + 2} - {a}_{n} )}^{2} \qquad [ Expression 2 ]$$

Subsequently, the contrast value P[PN] is compared with the maximum value among all the contrast values obtained so far (step S103), and if the contrast value P[PN] is greater than this maximum value (if YES at step S103), the maximum value is set to this contrast value P[PN] (step S105). Subsequently, the contrast value P[PN] is compared with the minimum value among all the contrast values obtained so far (step S107), and if the contrast value P[PN] is smaller than this minimum value (if YES at step S107), the minimum value is set to this contrast value P[PN] (step S109). Such operations for calculating and comparing the contrast value P[PN] at steps S101 through S109 are repeated to be performed on each of the five areas 0 through 4. After the completion of the operations at steps S101 through S109 on all the areas 0 through 4, control returns.

[Peak Check Process]

The peak (maximum value) check process that is performed at step S23 will be hereinafter discussed in detail with reference to the flow chart shown in FIG. 6. In the peak check process, a peak value (maximum value) of contrast is determined, on each of the five areas 0 through 4, from the contrast values P[PN] which are obtained at each lens position of the focusing lens group L1 (lens position PN) by moving the focusing lens group L1 stepwise. In the present embodiment of the focus detection method, the contrast values P[PN] obtained at two adjacent lens positions are compared with each other in a group of five contrast values P[PN] obtained at consecutive five lens positions from the closest (shortest) focus position to the infinite focus position to determine whether the contrast value increases a first predetermined number of times consecutively and subsequently decreases a second predetermined number of times consecutively. Specifically, if it is determined that the contrast value increases two times consecutively and subsequently decreases two times consecutively, the maximum contrast value P[PN] at this time is determined as a peak contrast value (maximum contrast value).

In the peak check process, firstly a lens position pulse Pulse[PN] is set to the current lens position (pulse number) PN of the focusing lens group L1 (step S201). When control firstly enters the peak check process, the lens position pulse Pulse[PN] is set to zero (0) representing the closest focus position.

Subsequently, it is determined whether the lens position PN is equal to or greater than “N×2” (step S203). “N” represents a predetermined number of times by which it is determined whether or not the contrast has consecutively increased and consecutively decreased. In this particular embodiment “N” is set to two. Therefore, if the lens position PN is not equal to or greater than four (4≦PN) (if NO at step S203), control proceeds to the subsequent area, or control returns in the case of the last area 4. If the lens position PN is equal to or greater than four (if YES at step S203), it is determined whether the contrast value P[PN] increases two times (since “N” is set to two) consecutively and subsequently decreases two times (since “N” is set to two) consecutively on the most-recent five contrast values from the current contrast value to a previous contrast value four positions (focus detection areas) behind the current contrast value (step S205). If the contrast value P[PN] does not increase two times consecutively and subsequently decrease two times consecutively on the group of the most-recent five contrast values (if NO at step S205), control proceeds to the subsequent area, or control returns in the case of the last area 4. When control returns, an image data is obtained to determine a contrast by moving the focusing lens group L1 toward the infinite focus position by one pulse, and thereafter control enters the flow chart shown in FIG. 6 again with the contrast data on the five areas 0 through 4 having been updated.

If the contrast value P[PN] increases two times consecutively and subsequently decreases two times consecutively on the group of the most-recent five contrast values P[PN−4] through P[PN] (if YES at step S205), a value corresponding to 80 percent of the contrast value P[PN−2] at the lens position (PN−2) (at which the contrast value is the maximum contrast value) is determined, and a lower limit value dat0 is set to this value (step S207). Subsequently, it is determined, as the first condition for reliability, whether either one of the two contrast values P[PN−4] and P[PN] at the opposite ends of the most-recent five contrast values, which determine the maximum contrast value, is smaller than the lower limit value dat0 (step S209). Namely, it is determined whether or not the difference between the peak contrast value and either one of the two contrast values at the opposite ends of the most-recent five contrast values is sufficiently large. If either one of the two contrast values P[PN−4] and P[PN] at the opposite ends of the most-recent five contrast values is not smaller than the lower limit value dat0 (if NO at step S209), control returns (control proceeds to the subsequent area, or control returns in the case of the last area 4). This is because the contrast varies only by a small amount, and accordingly it is assumed that the reliability of the obtained contrast data is low.

If it is determined that either one of the two contrast values P[PN−4] and P[PN] at the opposite ends of the most-recent five contrast values is smaller than the lower limit value dat0 (if YES at step S209), it is determined, as a second condition for reliability, whether the difference between the peak contrast value P[PN−2] and the minimum value of the contrast values obtained so far is greater than 10 percent of the peak contrast value P[PN−2] (step S211). If the difference between the peak contrast value P[PN−2] and the minimum value of the contrast values obtained is not greater than 10 percent of the peak contrast value P[PN−2] (if NO at step S211), control returns (control proceeds to the subsequent area, or control returns in the case of the last area 4) because the peak contrast value is so low that the reliability of the obtained contrast data can be assumed to be low.

If the difference between the peak contrast value P[PN−2] and the minimum value of the contrast values obtained is greater than 10 percent of the peak contrast value P[PN−2] (if YES at step S211), it is determined, as a third condition for reliability, whether the peak contrast value P[PN−2] is equal to or greater than the maximum value of the contrast values obtained so far; namely, it is determined whether the peak contrast value P[PN−2] is the greatest among all the detected contrast values (step S213).

If it is determined that the contrast value P[PN−2] is equal to or greater than the maximum contrast value of all the detected contrast values (if YES at step S213), a position index “Index” is set to the lens position (PN-2) at which the peak contrast value P[PN−2] has been obtained, and a peak existence flag “Status” is set to one (step S215). Subsequently, control proceeds to the subsequent area, or control returns in the case of the last area 4.

Note that the aforementioned position index “Index” indicates the lens position PN at which the peak contrast value P[PN−2] has been obtained, and the peak existence flag “Status” is a flag which identifies that a peak value (maximum value) of contrast has been obtained.

If it is determined that the peak contrast value P[PN−2] is not equal to or greater than the maximum contrast value of all the detected contrast values (if NO at step S213), namely, if it is determined that a contrast value greater than the peak contrast value P[PN−2] exists, control simply returns (control proceeds to the subsequent area, or control returns in the case of the last area 4). This is because there is a high possibility of the lens position, at which the peak contrast value P[PN−2] has been obtained, not being at an in-focus position.

Since the above described peak check process makes it possible to determine whether a peak contrast value is reliable by checking whether the contrast value increases two times consecutively and subsequently decreases two times consecutively on a group of contrast data obtained at consecutive five lens positions, a peak contrast value can be detected with a high degree of precision.

[Peak Calculation Process]

The peak calculation process that is performed at steps S29 and S421 will be hereinafter discussed in detail with reference to the flow chart shown in FIG. 7. In the peak calculation process, a more precise peak contrast value is determined by an approximate (interpolation) calculation using contrast values on the opposite sides of the peak contrast value P[PN] obtained at step S23.

A linear approximation expression (straight line) which passes through the point of a maximum contrast value (detected maximum contrast value) among the detected contrast values and the point of another contrast value obtained on the close-distance side, and another linear approximation expression (straight line) which passes through the points of two contrast values obtained on the infinite range side with respect to the point of the peak contrast value, are determined to obtain the point of intersection between the straight lines of these two linear approximation expressions. The x-coordinate of the point of intersection of the two straight lines is determined as a focus lens position of the focusing lens group (focused focal point) if the value of the y-coordinate (determined maximum contrast value) of the point of intersection of the two straight lines is greater than the detected maximum contrast value.

In the peak calculation process, firstly it is determined whether the peak existence flag “Status” is one, i.e., whether there is a peak contrast value (step S301). If the peak existence flag “Status” is not one (if NO at step S301), the peak calculation process is performed for the subsequent area. If the peak existence flag “Status” is 1 (if YES at step S301), a linear approximation process which includes operations at and after step S303 is performed. In this linear approximation, in regard to a straight line (Y=ax+b) which passes through the points of two contrast values including a peak contrast value and another straight line (Y=cx+d) which passes through the points of two contrast values including no peak value, gradients a and c and intersections b and d of the two straight lines are determined (step S303), and the x and y coordinates of the point of intersection of the two straight lines respectively determined by the two equations (Y=ax+b and Y=cx+d) are determined (step S305). The y-coordinate of the point of intersection is determined as a determined peak contrast value y, while the x-coordinate of the intersection is determined as a determined contrast-peak lens position x.

Subsequently, it is determined whether the peak contrast value P[Index] is smaller than the determined peak contrast value y (step S307). If the peak contrast value P[Index] is smaller than the determined peak contrast value y (if YES at step S307), operations at and after step S309 are performed. If the peak contrast value P[Index] is not smaller than the determined peak contrast value y (if NO at step S307), the peak existence flag “Status” is set to zero indicating that there is no peak contrast value (step S313). FIG. 13D corresponds to this case. When the peak contrast value P[Index] is smaller than the determined peak contrast value y, i.e., when the determined peak contrast value y is greater than the peak contrast value P[Index], the determined peak contrast value y is assumed to be a more precise peak value.

If the peak contrast value P[Index] is smaller than the determined peak contrast value y (if YES at step S307), the contrast value P[Index−1] and the contrast value P[Index+1] which are positioned on the opposite sides of the peak contrast value P[Index] are compared with each other to determine whether the contrast value P[Index+1] is greater than the contrast value P[Index−1] (step S309). FIGS. 13A, 13B and 13C correspond to this case.

It is determined at step S309 whether the contrast value P[Index+1], which is positioned closer to the long-distance side than the peak contrast value P [Index], is greater than the contrast value P[Index−1], which is positioned closer to the close-distance side than the peak contrast value P[Index], and it is determined at step S311 whether an approximate peak point X is greater than the peak contrast value P[Index] and smaller than the contrast value P[Index+1], which is positioned closer to the long-distance side than the peak contrast value P[Index]. If the contrast value P[Index+1] is greater than the contrast value P[Index−1] (if YES at step S309) and if the approximate peak point X is greater than the peak contrast value P[Index] and smaller than the contrast value P[Index+1] (if YES at step S311), a peak position PeakX is set to the approximate peak point X (step S317). FIGS. 13A and 13C correspond to this case.

If the contrast value P[Index+1] is greater than the contrast value P[Index−1] (if YES at step S309) and if the approximate peak point X is not greater than the peak contrast value P[Index] and smaller than the contrast value P[Index+1] (if NO at step S311), the peak existence flag “Status” is set to zero indicating that there is no peak contrast value (step S313).

If the contrast value P[Index+1] is not greater than the contrast value P[Index−1] (if NO at step S309) and if the approximate peak point X is greater than the contrast value P[Index−1] and smaller than the peak contrast value P[Index] (if YES at step S315), the peak position PeakX is set to the approximate peak point X (step S317). FIG. 13B corresponds to this case.

If the contrast value P[Index+1] is not greater than the contrast value P[Index−1] (if NO at step S309), and if the approximate peak point X is not greater than the contrast value P[Index−1] and smaller than the peak contrast value P[Index] (if NO at step S315), the peak existence flag “Status” is set to zero (step S319).

The above described operations at steps S301 through S319 are repeated for each peak contrast value P[Index], and further repeated for each of the five areas 0 through 4 to determine a peak contrast value which is assumed to be a real peak contrast value calculated by linear approximation.

[Area Selection Process]

The area selection process that is performed at step S31 will be hereinafter discussed in detail with reference to the flow chart shown in FIG. 8. In the area selection process, the following processes are performed: a process in which, if peak contrast values having high reliability have been obtained in the peak check process (shown in FIG. 6) performed at step S23, a peak contrast value at the closest distance is selected from among the obtained peak contrast values; a process in which, if no peak contrast values having high reliability have been obtained in the peak check process shown in FIG. 6 which is performed at step S23 and if more than one peak contrast value having the same position index exists, a lens position of the focusing lens group L1 which corresponds to an average of the more than one peak contrast value is regarded as an in-focus lens position; and a process in which, if no peak contrast values having high reliability have been obtained in the peak check process performed at step S23 and if more than one peak contrast value having the same position index does not exist, a lens position of the focusing lens group L1 which is predetermined in accordance with an ON/OFF state of an electronic flash is presumed to be at an in-focus lens position.

In the area selection process, firstly a variable maximum peak position PeakMax is set to a hexadecimal number FF corresponding to the infinite focus position and an error flag is set to one (step S401). Subsequently, operations at steps S403 through S409 are repeated to be performed on each of the five areas 0 through 4. The error flag “ERROR” is a flag indicating whether a peak contrast value has existed at a position closer to the closest position than the infinite position, and is set to zero if such a peak contrast value exists.

In the operations at steps S403 through S409, firstly it is determined whether the peak existence flag “Status” is one (step S403). If the peak existence flag “Status” is one (if YES at step S403), it is determined whether there is no error (step S405). If there is no error (if YES at step S405), it is determined whether the peak position PeakX is at a position closer to the close-distance side than the maximum peak position PeakMax (step S407). If the peak position PeakX is at a position closer to the close-distance side than the maximum peak position PeakMax (if YES at step S407), the maximum peak position PeakMax is set to the peak position PeakX, and the error flag “ERROR” is set to zero indicating that there is no error (step S409). Thereafter, control returns to the operation at step S403 so that the operations at steps S403 through S409 are performed on the subsequent area (focus detection area). Accordingly, the peak position PeakX closest to the close-distance side is selected from among the peak positions PeakX obtained on each of the five areas 0 through 4 so that the maximum peak position PeakMax is set to the peak position PeakX.

If it is determined at step S403 that the peak existence flag “Status” is not one (if NO at step S403), if it is determined at step S405 there is error (if NO at step S405), or if it is determined at step S407 that the peak position PeakX is not at a position closer to the close-distance side than the maximum peak position PeakMax (if NO at step S407), control skips the operation at step S409 and returns to step S403 so that the operations at steps S403 through S409 are performed on the subsequent area (focus detection area). The operations at steps S403 through S409 are repeated to be performed on each of the five areas 0 through 4 to determine the peak position PeakX at the closest distance. If there is at least one peak position PeakX, the operation at step S409 is performed, so that the maximum peak position PeakMax is set to the peak position PeakX while the error flag “ERROR” is set to zero. However, the error flag “ERROR” remains set at one if it is determined that there is no peak position PeakX.

Upon the completion of the operations at steps S403 through S409 for determining the peak position PeakX at the closest distance for all the five areas 0 through 4, it is determined whether the error flag “Error” is zero (step S411). If the error flag “Error” is zero (if YES at step S411), the maximum peak position PeakMax is converted into a driving pulse number because the maximum peak position PeakMax has been set to the peak position PeakX at step S409 (step S413). Subsequently, control returns.

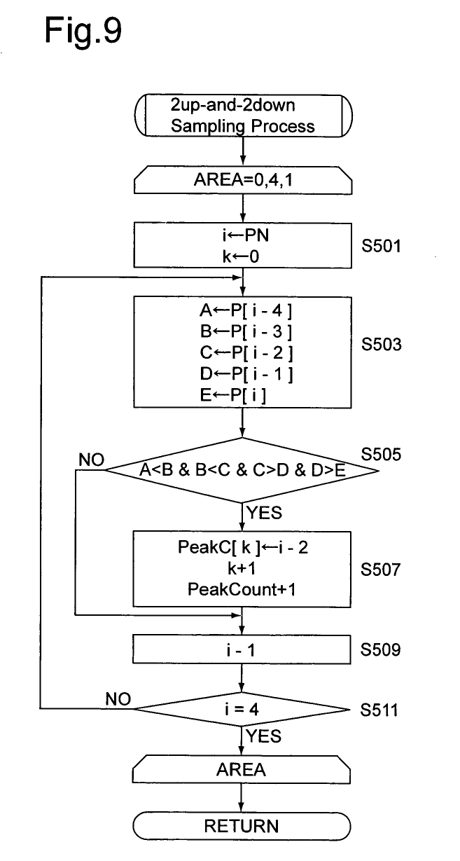

If the error flag “Error” is not zero (if NO at step S411), a process (2Up-and-2Down sampling process shown in FIG. 9) of sampling the position index “Index” of the peak contrast value which increases two times consecutively and subsequently decreases two times consecutively on a group of five contrast data on each of the five areas 0 through 4 is performed (step S415). The difference between this process and the peak check process performed at step S23 is that the reliability of contrast data is not evaluated in the process at step S415.

Subsequently, the position indexes “Index” sampled at step S415 are accumulated to select the position index “Index” which exists in at least a predetermined number “n” of areas of the five areas 0 through 4 at the same position index “Index” (step S417), and it is determined whether there is at least a predetermined number “n” of areas at the same position index “Index” (step S419).

Note that the predetermined number “n” is a freely selectable number which is predetermined to be equal to or smaller than the total number of the areas 0 through 4. In this particular embodiment, the number “n” is set to three. In addition, it is possible for the position index “Index” within a predetermined range to be selected though the position index “Index” which exists in at least a predetermined number “n” areas of the five areas 0 through 4 at the same position index “Index” is selected in the present embodiment of the focus detection method.

If it is determined at step S419 that there is not at least the predetermined number “n” of areas (if NO at step S419), a normal error process is performed (step S427), and control returns. The normal error process is performed to set a driving pulse number corresponding to an ON/OFF state of an electronic flash, and in the normal error process the LED 29 illuminates or blinks in a manner to indicate that an in-focus state has not been achieved.

For instance, when the flash is ON, the driving pulse number is set to a number capable of moving the focusing lens group L1 to a longest-distance point within a flash working range or a point within a depth of focus within the flash working range.

When the flash is OFF, the driving pulse is set to a number capable of moving the focusing lens group L1 to a position in which an object at a hyperfocal distance, at a close-distance point or at a distance of three meters is focused, or to a fixed position which is set at a position farther away as the focal length increases.

If it is determined at step S419 that there is at least a predetermined number “n” of areas (if YES at step S419), the peak calculation process (see in FIG. 7) is performed (step S421). In this process, a precise peak contrast value is determined in accordance with five peak contrast values, the center of which corresponds to the position index “Index”. The peak check process at step S421 is the same as that shown in FIG. 7.

Subsequently, an average of the obtained peak positions PeakX is calculated, and an average peak position PeakAve is set to this average (step S423), and the average peak position PeakAve is converted into a driving pulse number (step S425). Subsequently, control returns. Namely, the average peak position PeakAve is regarded as an in-focus position. In this case, the LED 29 illuminates or blinks in a manner to indicate that focus is not achieved.

[2Up-and-2Down Sampling Process]

The 2up-and-2down sampling process which is performed at step S415 will be hereinafter discussed in detail with reference to the flow chart shown in FIG. 9. In this flow chart, a peak contrast value is detected by determining whether the contrast value increases two times consecutively and subsequently decreases two times consecutively on a group of contrast data (obtained contrast values) at consecutive five lens positions in a direction from the closest focusing distance toward the infinite focus position on each of the five areas 0 through 4, one by one, by repeating operations at steps S501 through S511, and a process of sampling a peak contrast value at the closest distance by updating the peak contrast value every time it is determined is performed on contrast data on all the five areas 0 through 4. The difference between the 2Up-and-2Down sampling process and the peak check process shown in FIG. 6 is that the reliability of contrast data is not evaluated in the 2up-and-2down sampling process.

Firstly, a pulse number (variable) i is set to the lens position (pulse number) PN corresponding to the infinite focus position, and a variable k is set to zero (step S501). The variable k indicates the number of the peak contrast value. Note that the variable 0 indicates the first peak contrast value because the initial value of the variable k is zero.

Subsequently, a first variable A, a second variable B, a third variable C, a fourth variable D and a fifth variable E are set to a contrast value P[i−4], a contrast value P[i−3], a contrast value P[i−2], a contrast value P[i−1] and a contrast value P[i], respectively (step S503). Subsequently, it is determined whether the first variable A is smaller than the second variable B, whether the second variable B is smaller than the first variable C, whether the first variable C is greater than the fourth variable D, and whether the fourth variable D is greater than the fifth variable E (step S505). Namely, it is determined at step S505 whether the contrast value increases two times consecutively and subsequently decreases two times consecutively. If the contrast value increases two times consecutively and subsequently decreases two times consecutively (if YES at step S505), a peak position index PeakC[k] is set to the pulse position i−2, the variable k is increased by one, and a peak counter PeakCount is increased by one (step S507). If the result of the determination at step S505 is NO, control skips the operation at step S507. Subsequently, the pulse number i is decreased by one (step S509), and it is determined whether the pulse number i is four (step S511). If the pulse number i is not four (if NO at step S511), control returns to step S503 to repeat the operations at steps S503 through S511 until the pulse number i becomes four.

Upon the pulse number i becoming four (if YES at step S511), control returns to step S501 to set the pulse number i and the variable k to the lens position PN and zero, respectively, and the operations at steps S503 through S511 are performed on each of the remaining four areas 1 through 4 until the pulse number i becomes four. Namely, the operations at steps S503 through S511 are performed on all the five areas 0 through 4. The peak position index PeakC[k] is sampled on each of the five areas 0 through 4 by the above described operations.

FIG. 11 shows a relationship between contrast data obtained by the contrast AF process and the position of the focusing lens group L1 by way of example. In this example, one peak position index PeakC[0](=6) is sampled from the area 0, one peak position index PeakC[0](=3) is sampled from the area 1, three peak position indexes PeakC[0](=2), PeakC[1](=6) and PeakC[2](=11) are sampled from the area2, one peak position index PeakC[0](=3) is sampled from the area 3, and one peak position index PeakC[0](=6) is sampled from the area 4.

[2up-and-2down Selection Process]

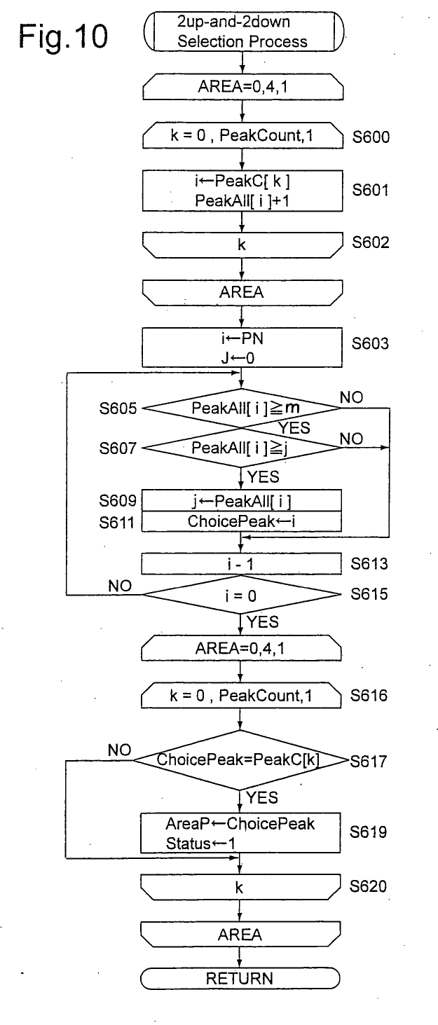

The 2up-and-2down selection process that is performed at step S417 will be hereinafter discussed with reference to the flow chart shown in FIG. 10. In this process, the peak position indexes PeakC[k] which exist in each of the five areas 0 through 4 and are sampled in the 2Up-and-2Down sampling process shown in FIG. 9 are accumulated to select the peak position index PeakC[k] which exists in the largest number of areas among the five areas 0 through 4, and the index is updated in an area AreaP (e.g., the area including areas 0, 2 and 4 in the illustrated embodiment as shown in FIG. 11) in which the finally-selected peak contrast values exist.

In the 2up-and-2down selection process, firstly, from the variable k=0, a process of setting the variable pulse number i to the pulse number of the peak position index PeakC[k] and increasing a peak number PeakAll [i] by one (step S601) is repeated while increasing the variable k in increments of one until the variable k becomes greater than the peak counter PeakCount (step S600, step S601 and S602). This repetitive process at steps S600, S601 and S602 is repeated to be performed on each of the five areas 0 through 4 to accumulate the peak position indexes PeakC[k].

In the example shown in FIG. 11, one peak position index PeakC [0] (=6) is accumulated from the area 0, one peak position index PeakC[0](=3) is accumulated from the area 1, three peak position indexes PeakC [0] (=2), PeakC[1](=6) and PeakC[2](=11) are accumulated from the area2, one peak position index PeakC[0](=3) is accumulated from the area 3, and one peak position index PeakC [0] (=6) is accumulated from the area 4. FIG. 12A is a table showing the relationship between the pulse number (variable) i and the peak number PeakAll[i].

Subsequently, the maximum peak number of the peak numbers PeakAll[i] is selected among all the index numbers PeakAll[i] including a predetermined number “m” of peak numbers. In the present embodiment, firstly the pulse number i, to which the lens position PN is set, is set to the maximum lens position PN, while a variable j for selecting the position index whose counter is the greatest is set to zero (step S603). Subsequently, it is determined whether the peak number PeakAll[i] is equal to or greater than the number “m” (step S605). If the peak number PeakAll[i] is equal to or greater than the number “m” (if YES at step S605), it is determined whether the peak number PeakAll[i] is equal to or greater than the variable j (step S607). If the peak number PeakAll[i] is equal to or greater than the variable j (if YES at step S607), the variable j is set to the peak number PeakAll[i] while a choice peak (selection peak) ChoicePeak is set to the pulse number i of this peak number PeakAll[i] (step S611). Subsequently, the pulse number i is decreased by one (step S613), and it is determined whether the pulse number i is zero (step S615). If the pulse number i is not zero (if NO at step S615), control returns to the operation at step S605.

If the PeakAll[i] is not equal to or greater than the predetermined number “m” (if NO at step S605), or if the peak number PeakAll[i] is not equal to or greater than the variable j (if NO at step S607) even if the PeakAll[i] is equal to or greater than the predetermined number “m” (if YES at step S605), control skips the operations at steps S609 and S611 to simply proceed to step S615. If the pulse number i is not zero (if NO at step S615), control returns to the operation at step S605. Therefore, the above described operations at steps S605 through step S613 are repeated until the pulse number i becomes zero.

In this particular example shown in FIG. 11, the peak number PeakAll[6] when the pulse number i is six (i=6) is selected so that the choice peak ChoicePeak is set to the peak number PeakAll[6].

Subsequently, the peak position index PeakC[k] identical to the choice peak ChoicePeak is repeatedly selected a predetermined number of times corresponding to the peak counter PeakCount from the variable k of zero (k=0) successively on each of the five areas 0 through 4.

In the present embodiment, firstly it is determined whether the choice peak ChoicePeak is equal to the peak position indexes PeakC[k] (step S617). If the choice peak ChoicePeak is not equal to the peak position indexes PeakC[k] (if NO at step S617), the variable k is increased by one (steps S620 and S616) and the check operation at step S617 is repeated. If the choice peak ChoicePeak is equal to the peak position indexes PeakC[k] (if YES at step S617), the area AreaP is set to the choice peak ChoicePeak and the peak existence flag “Status” is set to one (step S619). Subsequently, the variable k is increased by one (steps S620 and S616), and the operations at steps S617 and S619 are repeated. Upon the variable k becoming the peak counter PeakCount, the operations at steps S616 through S620 are repeated on the subsequent area, so that the operations at steps S616 through S620 are repeated to be performed on each of all the five areas 0 through 4.

Due to the above described 2Up-and-2Down selection process, the area AreaP is set to the areas 0, 2 and 4 at the pulse number i (i=6) of the in the particular example shown in FIG. 11. Thereafter, the peak calculation process at step S421 is performed based on two contrast data on the opposite sides of the peak contrast value in the area AreaP (at the pulse number i=6 in each of the three areas 0, 2 and 4), and the average peak position PeakAve is set to the average of the obtained peak positions PeakX.

In the case where the average peak position PeakAve is set, a warning mark or message informing the user that the contrast data is not reliable is indicated on the LCD monitor 17.

As can be understood from the above description, in the case where a peak contrast value having high reliability is not obtained on an object such as a low-contrast object, a plurality of peak contrast values are determined at the same lens position or in a predetermined positional range of the focusing lens group on a plurality of focus detection areas even if the reliability of the obtained contrast data is low, and if such a plurality of peak contrast values are obtained, a focusing process is performed on the assumption that an object which is to be photographed is at a position associated with the obtained plurality of peak contrast values or in the vicinity thereof in the present embodiment of the focus detection method. Accordingly, there is a high possibility of a portion of the object which is positioned within at least one of the five focus detection areas being brought into focus, which prevents excessive defocusing from occurring.

Although the five focus detection areas (12A, 12B, 12C, 12D and 12E) are arranged in the shape of a cross in the present embodiment of the contrast AF process, the present invention is not limited solely to this particular embodiment; the number of the focus detection areas and the arrangement thereof are optional. Moreover, the algorithm for detecting peak contrast values is not limited solely to the above described particular algorithm, in which it is determined whether the contrast value increases two times consecutively and subsequently decreases two times consecutively. Furthermore, a manner of determining the reliability of contrast data is not limited solely to that in the above described embodiment.

In the algorithm for determining a focus position in the case that the reliability of contrast data is low, the peak contrast value at the closest distance is selected from among the peak contrast values at the same lens position which exist in at least three focus detection areas among the five focus detection areas in the above described embodiment. However, in the case where there is detected only one lens position at which the maximum number of peak contrast values exists, regardless of object distance, this lens position can be selected. Moreover, conditions for selecting the lens position can be changed in accordance with an ON/OFF state of an electronic flash. For instance, the lens position at a longest-distance point within a flash working range can be selected when the flash is ON.

Although the number of peak contrast values obtained in at least a predetermined number of focus detection areas is accumulated on each lens position in the above described embodiment, each lens position can be extended to a predetermined range, e.g., a range extending over at least two adjacent lens positions. For instance, the number of peak contrast values obtained in at least a predetermined number of focus detection areas can be accumulated by shifting the lens position in increments of one lens position in a manner like “i=1, 2, i=2, 3, i=3, 4, . . . ”.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A focus detection method for detecting a focus state of an object image in accordance with contrast values of said object image at a plurality of focus detection areas, respectively, said focus detection method comprising:
capturing a plurality of said object images while moving a focusing lens group of a photographing lens stepwise within a predetermined range of movement of said focusing lens group;
determining a contrast value of each said captured plurality of object images;
detecting at least one peak contrast value, which satisfies a predetermined condition for reliability, from said determined contrast values, on each of said plurality of focus detection areas, obtained during movement of said focusing lens group; and
selecting a peak contrast value detected in each of a predetermined number of areas of said plurality of focus detection areas one of at a same position of said focusing lens group and in a predetermined positional range of said focusing lens group, in the case said peak contrast value which satisfies said predetermined condition for reliability is not detected.

2. The focus detection method according to claim 1, wherein said predetermined condition comprises a first condition wherein a difference between said detected peak contrast value and a comparative peak contrast value is one of equal to and greater than a predetermined value.

3. The focus detection method according to claim 1, wherein said predetermined condition comprises a second condition wherein a difference between said detected peak contrast value and a minimum contrast value among all contrast values obtained in one of said plurality of focus detection areas, in which said detected peak contrast value is detected, is one of equal to and greater than a predetermined value.

4. The focus detection method according to claim 1, wherein said predetermined condition comprises a third condition wherein said detected peak contrast value is the greatest among all contrast values obtained in one of said plurality of focus detection areas in which said detected peak contrast value is detected.

5. The focus detection method according to claim 1, wherein said detected peak contrast value is designated as a peak contrast value which increases a plurality of times consecutively and subsequently decreases a plurality of times consecutively along said direction of movement of said focusing lens group.

6. The focus detection method according to claim 1, wherein, if said peak contrast value which satisfies said predetermined condition for reliability is not detected and if at least a predetermined number of peak contrast values one of at said same position of said focusing lens group and in said predetermined positional range of said focusing lens group are detected, a peak contrast value one of at a lens position of said focusing lens group which corresponds to a closest distance and in a predetermined positional range of said focusing lens group which corresponds to a closest distance is selected in the selecting step.

7. The focus detection method according to claim 1, wherein, if said peak contrast value which satisfies said predetermined condition for reliability is not detected and if at least a predetermined number of peak contrast values one of at said same position of said focusing lens group and in said predetermined positional range of said focusing lens group are selected in the selecting step, an average position of a plurality of lens positions of said focusing lens group which are obtained from said selected predetermined number of peak contrast values is designated as an in-focus position of said focusing lens group.

8. The focusing detection method according to claim 1, further comprising:
moving said focusing lens group stepwise when said focus state of said object image is detected.

9. The focus detection method according to claim 1, wherein said contrast values of said object image are measured via an image pickup device.

10. A focus detection apparatus for detecting a focus state of an object image in accordance with contrast values of said object image at a plurality of focus detection areas, respectively, said focus detection apparatus comprising:
a lens drive mechanism for moving a focusing lens group of a photographing lens system within a predetermined range of movement;
an image-capturing device for capturing a plurality of said object images while moving said focusing lens group stepwise within said predetermined range of movement of said focusing lens group;
a contrast value determining device for determining a contrast value of each said captured plurality of object images; and
a controller for detecting at least one peak contrast value, which satisfies a predetermined condition for reliability, from said determined contrast values, on each of said plurality of focus detection areas, obtained during movement of said focusing lens group,
wherein said controller selects a peak contrast value detected in each of a predetermined number of areas of said plurality of focus detection areas one of at a same position of said focusing lens group and in a predetermined positional range of said focusing lens group, in the case where said peak contrast value which satisfies said predetermined condition for reliability is not detected.

11. The focus detection apparatus according to claim 10, wherein, said controller selects a peak contrast value one of at a lens position of said focusing lens group which corresponds to a closest distance and in a predetermined positional range of said focusing lens group which corresponds to a closest distance, if said peak contrast value which satisfies said predetermined condition for reliability is not detected and if at least a predetermined number of peak contrast values one of at said same position of said focusing lens group and in said predetermined positional range of said focusing lens group are detected.

12. The focus detection apparatus according to claim 10, wherein, said controller calculates an average position of a plurality of lens positions of said focusing lens group which are obtained from said selected predetermined number of peak contrast values and designates said average position as an in-focus position of said focusing lens group, if said peak contrast value which satisfies said predetermined condition for reliability is not detected and if at least a predetermined number of peak contrast values one of at said same position of said focusing lens group and in said predetermined positional range of said focusing lens group are selected.

13. The focusing detection method according to claim 10, wherein said controller moves said focusing lens group stepwise when said focus state of said object image is detected.

14. The focus detection apparatus according to claim 10, wherein said contrast values of said object image are measured via said image-capturing device.
